(19) United States
(12) Patent Application Publication
(10) Pub. No.: US 2024/0284383 A1
(43) Pub. Date: Aug. 22, 2024

(54) SIGNALING FOR APERIODIC SOUNDING REFERENCE SIGNALS FOR POSITIONING

(71) Applicant: QUALCOMM Incorporated, San Diego, CA (US)

(72) Inventors: Alexandros MANOLAKOS, Escondido, CA (US); Weimin DUAN, San Diego, CA (US); Muhammad Sayed Khairy ABDELGHAFFAR, San Jose, CA (US)

(21) Appl. No.: 18/567,679

(22) PCT Filed: Jun. 2, 2022
(86) PCT No.: PCT/US2022/072729

§ 371 Date: Dec. 6, 2023

(30) Foreign Application Priority Data
Jul. 15, 2021 (GR) 20210100476

(51) Int. Cl. H04W 64/00; H04L 5/00; H04W 72/0446; H04W 72/232

(52) U.S. Cl. CPC H04W 64/00; H04L 5/0051; H04W 72/0446; H04W 72/232

(57) ABSTRACT

Disclosed are techniques for wireless communication. In an aspect, a location server may send, and a base station may receive, a request for positioning information. The base station may send, and the location server may receive, sounding reference signal (SRS) configuration information comprising first information that describes a frame structure used by the base station and second information that identifies, based on the frame structure used by the base station, an available slot with respect to a reference for an aperiodic SRS transmission, wherein an available slot comprises a slot that has enough uplink symbols, flexible symbols, or both, in the time domain for all SRS resources of the aperiodic SRS transmission.

### CROSS-REFERENCE TO RELATED APPLICATIONS

The present Application for Patent claims the benefit of GR Application No. 20210100476, entitled “SIGNALING FOR APERIODIC SOUNDING REFERENCE SIGNALS FOR POSITIONING”, filed Jul. 15, 2021, and is a national stage application, filed under 35 U.S.C. § 371, of International Patent Application No. PCT/US2022/072729, entitled, “SIGNALING FOR APERIODIC SOUNDING REFERENCE SIGNALS FOR POSITIONING”, filed Jun. 2, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data. Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a base station includes receiving, from a location server, a request for positioning information, and sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a method of wireless communication performed by a location server includes sending, to a base station, a request for positioning information, and receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a base station (BS) includes a memory; at least one transceiver; and at least one processor communicatively coupled to the memory and the at least one transceiver, the at least one processor configured to: receive, via the at least one transceiver, from a location server, a request for positioning information; and send, via the at least one transceiver, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a location server (LS) includes a memory: at least one transceiver; and at least one processor communicatively coupled to the memory and the at least one transceiver, the at least one processor configured to: send, via the at least one transceiver, to a base station, a request for positioning information; and receive, via the at least one transceiver, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a base station (BS) includes means for receiving, from a location server, a request for positioning information; and means for sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a location server (LS) includes means for sending, to a base station, a request for positioning information; and means for receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a non-transitory computer-readable medium storing computer-executable instructions that, when executed by a base station (BS), cause the BS to: receive, from a location server, a request for positioning information; and send, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

In an aspect, a non-transitory computer-readable medium storing computer-executable instructions that, when executed by a location server (LS), cause the LS to: send, to a base station, a request for positioning information, and receive, from the base station. SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a signaling and event diagram illustrating an example conventional positioning procedure for multi-RTT positioning.

FIGS. 6A and 6B illustrate triggering for aperiodic SRS for positioning according to some aspects of the present disclosure.

FIGS. 7A and 7B are flowcharts showing portions of an example process associated with signaling for aperiodic SRS for positioning according to aspects of the present disclosure.

FIGS. 8A and 8B are flowcharts showing portions of an example process associated with signaling for aperiodic SRS for positioning according to aspects of the disclosure

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.). Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-cNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

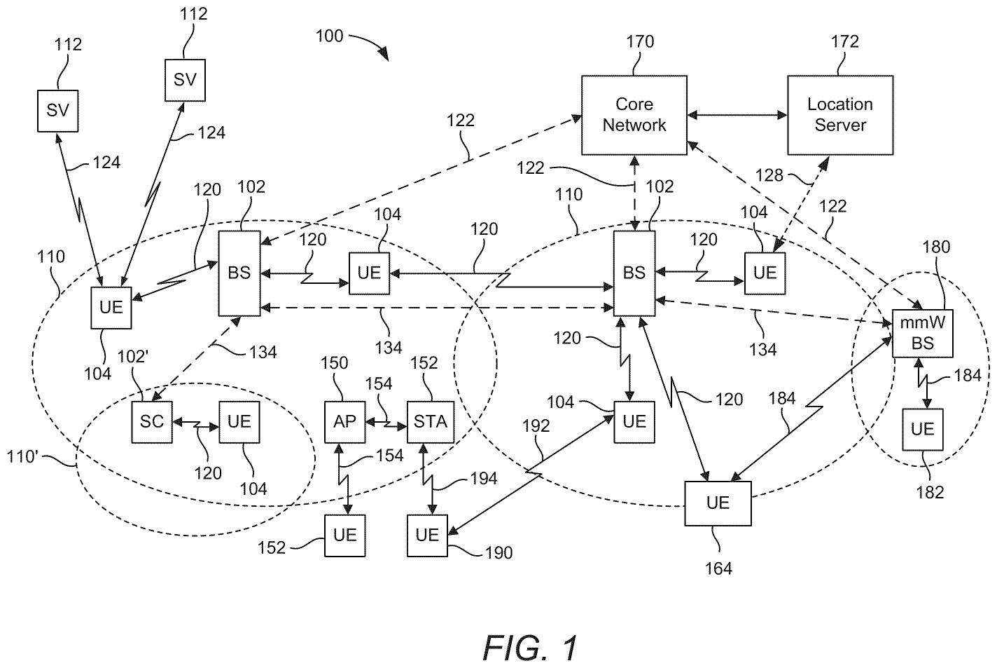

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC))through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 174, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). The mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

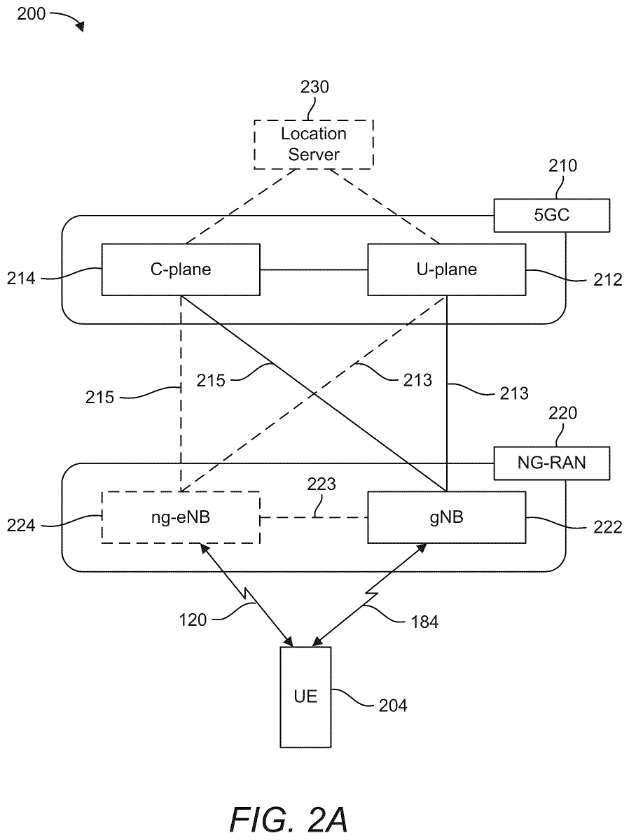

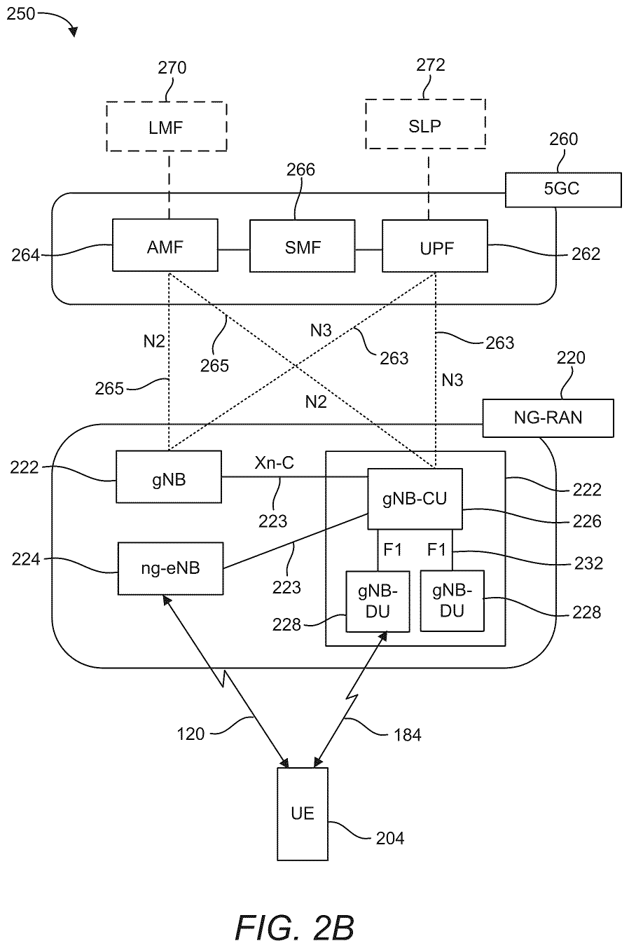

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-cNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-cNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control(RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

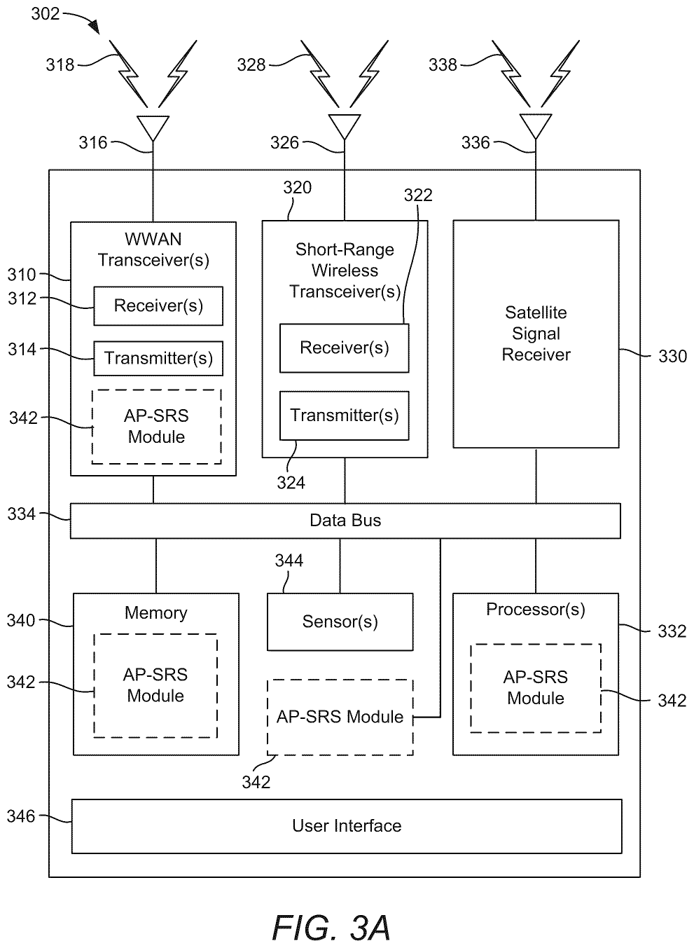

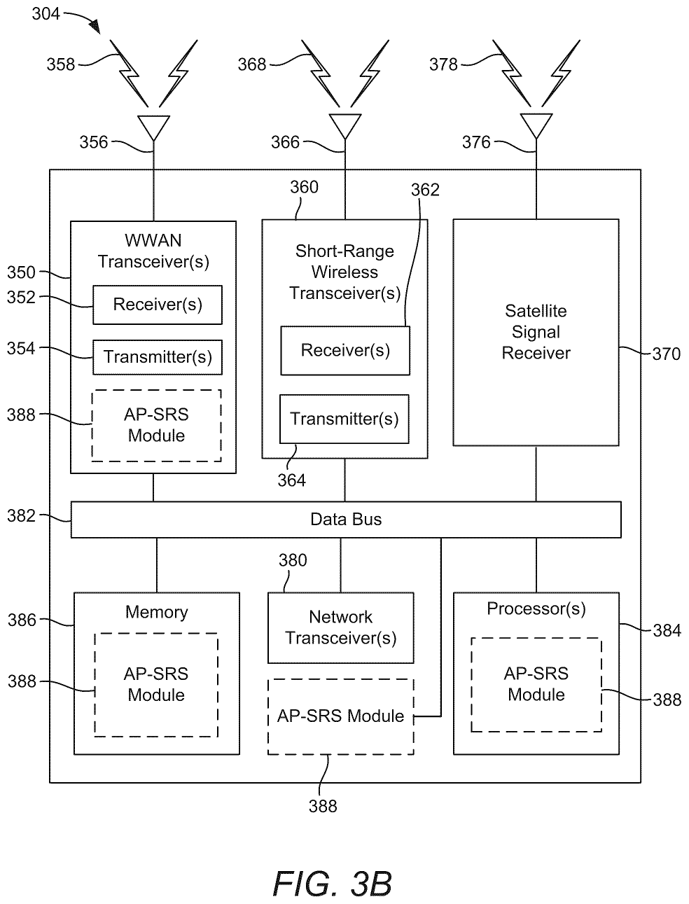

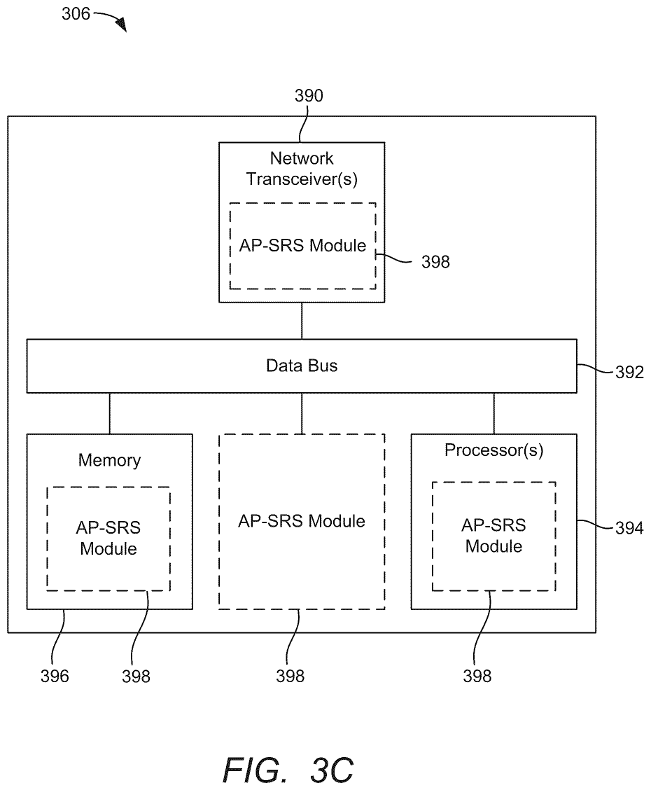

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, ZigbeeV, Z-Wavc@x), PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360)may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include AP-SRS module 342, 388, and 398, respectively. The AP-SRS module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the AP-SRS module 342, 388, and 398 may be external to the processors 332, 384, and 394 (e.g., part of a modem processing system, integrated with another processing system, etc.). Alternatively, the AP-SRS module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the AP-SRS module 342, which may be, for example, part of the one or more WWAN transceivers 310, the memory 340, the one or more processors 332, or any combination thereof, or may be a standalone component. FIG. 3B illustrates possible locations of the AP-SRS module 388, which may be, for example, part of the one or more WWAN transceivers 350, the memory 386, the one or more processors 384, or any combination thereof, or may be a standalone component. FIG. 3C illustrates possible locations of the AP-SRS module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity.” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the AP-SRS module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

Various frame structures may be used to support downlink and uplink transmissions between network nodes (e.g., base stations and UEs).

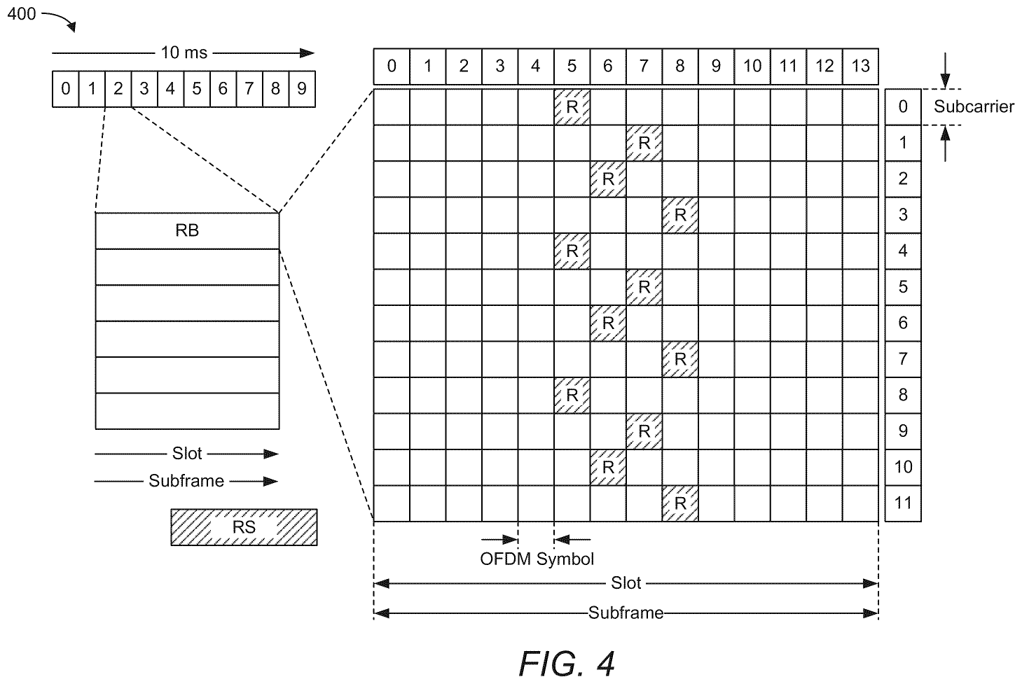

FIG. 4 is a diagram 400 illustrating an example frame structure, according to aspects of the disclosure. The frame structure may be a downlink or uplink frame structure. Other wireless communications technologies may have different frame structures and/or different channels. LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K)orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25.2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 25.5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=⁴) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 10 W. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=³), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcariers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

In an aspect, the reference signal carried on the REs labeled “R” may be SRS. SRS transmitted by a UE may be used by a base station to obtain the channel state information (CSI) for the transmitting UE. CSI describes how an RF signal propagates from the UE to the base station and represents the combined effect of scattering, fading, and power decay with distance. The system uses the SRS for resource scheduling, link adaptation, massive MIMO, beam management, etc.

A collection of REs that are used for transmission of SRS is referred to as an “SRS resource.” and may be identified by the parameter “SRS-ResourceId.” The collection of resource elements can span multiple PRBs in the frequency domain and ‘N’ (e.g., one or more) consecutive symbol(s) within a slot in the time domain. In a given OFDM symbol, an SRS resource occupies one or more consecutive PRBs. An “SRS resource set” is a set of SRS resources used for the transmission of SRS signals, and is identified by an SRS resource set ID (“SRS-ResourceSetId”).

The transmission of SRS resources within a given PRB has a particular comb size (also referred to as the “comb density”). A comb size ‘N’ represents the subcarrier spacing (or frequency/tone spacing) within each symbol of an SRS resource configuration. Specifically, for a comb size ‘N,’ SRS are transmitted in every Nth subcarrier of a symbol of a PRB. For example, for comb-4, for each symbol of the SRS resource configuration, REs corresponding to every fourth subcarrier (such as subcarriers 0, 4, 8) are used to transmit SRS of the SRS resource. In the example of FIG. 4, the illustrated SRS is comb-4 over four symbols. That is, the locations of the shaded SRS REs indicate a comb-4 SRS resource configuration.

Currently, an SRS resource may span 1, 2, 4, 8, or 12 consecutive symbols within a slot with a comb size of comb-2, comb-4, or comb-8. The following are the frequency offsets from symbol to symbol for the SRS comb patterns that are currently supported. 1-symbol comb-2: {0}; 2-symbol comb-2: {0, 1}; 2-symbol comb-4: {0, 2}; 4-symbol comb-2: {0, 1, 0, 1}: 4-symbol comb-4: {0, 2, 1, 3} (as in the example of FIG. 4); 8-symbol comb-4: {0, 2, 1, 3, 0, 2, 1, 3}; 12-symbol comb-4: {0, 2, 1, 3, 0, 2, 1, 3, 0, 2, 1, 3}; 4-symbol comb-8: {0, 4, 2, 6}: 8-symbol comb-8: {0, 4, 2, 6, 1, 5, 3, 7}; and 12-symbol comb-8: {0, 4, 2, 6, 1, 5, 3, 7, 0, 4, 2, 6}.

Generally, as noted above, a UE transmits SRS to enable the receiving base station (either the serving base station or a neighboring base station) to measure the channel quality (i.e., CSI) between the UE and the base station. However, SRS can also be specifically configured as uplink positioning reference signals for uplink-based positioning procedures, such as uplink time difference of arrival (UL-TDOA), round-trip-time (RTT), uplink angle-of-arrival (UL-AoA), etc. As used herein, the term “SRS” may refer to SRS configured for channel quality measurements or SRS configured for positioning purposes. The former may be referred to herein as “SRS-for-communication” and/or the latter may be referred to as “SRS-for-positioning” or “positioning SRS” when needed to distinguish the two types of SRS.

Several enhancements over the previous definition of SRS have been proposed for SRS-for-positioning (also referred to as “UL-PRS”), such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a downlink reference signal or SSB from a neighboring TRP. Further still, one SRS resource may be transmitted outside the active BWP, and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There also may be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. All of these are features that are additional to the current SRS framework, which is configured through RRC higher layer signaling (and potentially triggered or activated through a MAC control element (MAC-CE) or DCI).

A UE may be configured to transmit SRS signals periodically or aperiodically. An aperiodic SRS (AP-SRS) is transmitted in response to a trigger, such as an indication received in a downlink control information (DCI) message. In conventional networks (which may also be referred to herein as “legacy” networks), each AP-SRS is associated with a specific slot offset with respect to the DCI that triggered the SRS. A slot offset=0 means that the AP-SRS is transmitted in the same slot as the DCI, a slot offset=1 means that the AP-SRS is transmitted in the first slot after the DCI.

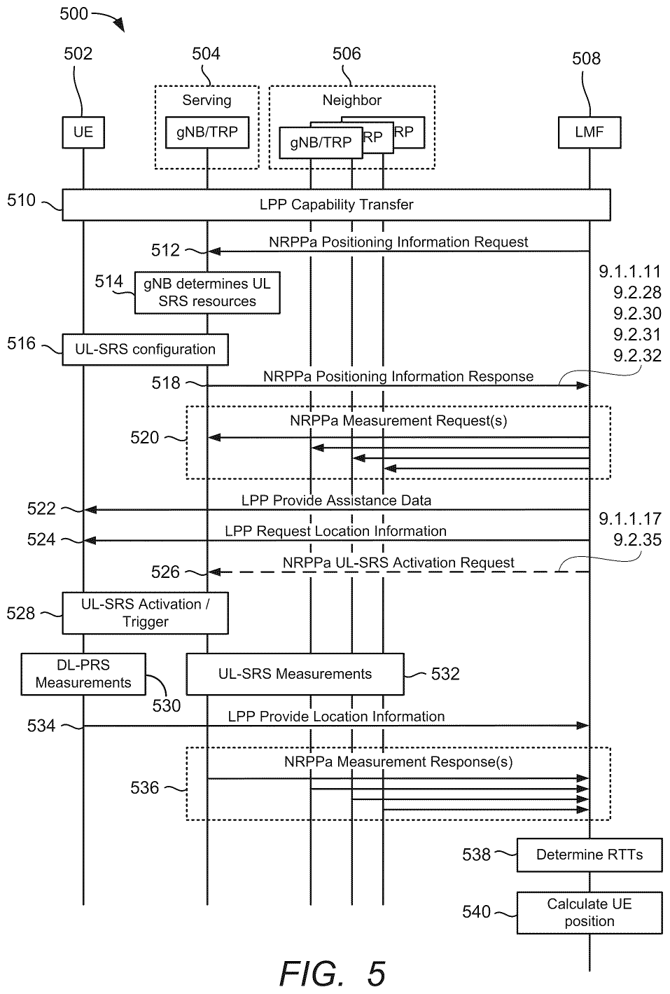

FIG. 5 is a signaling and event diagram illustrating an example positioning procedure 500 for multi-RTT positioning. FIG. 5 illustrates an example involving a UE 502, a serving gNB 504, a set of one or more neighbor gNB/TRP 506 (which may be referred to herein as TRPs 506), and an LMF 508. In the example illustrated in FIG. 5, the process includes the following steps.

The LMF 508 requests and receives the positioning capabilities of the UE 502 (block 510). The LMF 508 requests UL SRS configuration information for the UE 502, e.g., via a new radio (NR) positioning protocol A (NRPPa) message, such as an NRPPa Positioning Information Request message 512. The LMF 508 may provide any assistance data needed by the serving gNB 504 (pathloss reference, spatial relation. SSB config, etc.).

The serving gNB 504 determines the resources available for UL-SRS (block 514) and configures the target device with the UL-SRS resource sets (block 516). The serving gNB 504 provides the UL-SRS configuration information to the LMF 508, e.g., via an NRPPA Positioning Information Response message 518.

The SRS configuration is defined in 3GPP TS 38.455 version 16.3.0 (hereinafter, “TS 38.455”), section 9.2.28, which specifies SRS resource sets such as defined in TS 38.455, section 9.2.31 and which specifies positioning SRS resource sets such as defined in TS 38.455, section 9.2.32. A portion of TS 38.455, section 9.2.31 is shown below:

TABLE 1
TS 38.455, section 9.2.31,
“SRS Resource Set”

| IE/Group Name | IE Type and Reference |
|---|---|
| SRS Resource Set ID | INTEGER(0..15) |
| SRS Resource ID List | |
| SRS Resource ID | INTEGER(0..63) |
| CHOICE Resource Set Type | |
| aperiodic | |
| SRS Resource Trigger | INTEGER(1..3) |
| Slot offset* | INTEGER(0..32) |

*Offset in number of slots, where value 0 indicates no offset.

As can be seen in section 9.2.31, for SRS resource sets, each AP-SRS resource shares the same trigger and same slot offset. A portion of TS 38.455, section 9.2.32 is shown below:

TABLE 2
TS 38.455, section 9.2.32,
“Positioning SRS Resource Set”

| IE/Group Name | IE Type and Reference |
|---|---|
| Positioning SRS Resource Set ID | INTEGER(0..15) |
| Positioning SRS Resource ID List | INTEGER(0..63) |
| Positioning SRS Resource ID | |
| CHOICE Resource Type | |
| aperiodic | |
| SRS Resource Trigger | INTEGER(1.3) |

As can be seen in section 9.2.32, for positioning SRS resource sets, each AP-PosSRS resource shares the same trigger, but there is no group definition for Slot Offset. Instead, each AP-PosSRS resource has its own slot offset, as defined in TS. 38.455, section 9.2.30, a portion of which is shown below:

TABLE 3
TS 38.455, section 9.2.30,
“Positioning SRS Resource Set”

| IE/Group Name | IE Type and Reference |
|---|---|
| Positioning SRS Resource ID | INTEGER(0..63) |
| CHOICE Resource Type Positioning | |
| aperiodic | |
| slot offset | INTEGER(0.32) |

The LMF 508 selects the candidate TRPs 506 and provides the UL SRS configuration to the neighbor TRPs 506 (message(s) 520). The message(s) include all information required to enable the TRPs 506 to perform the UL measurements. The LMF 508 sends an LPP Provide Assistance Data message 522 to the UE 502. The message 520 includes any required assistance data for the UE 502 to perform the necessary DL measurements. The LMF 508 sends a LPP Request Location Information message 524 to request Multi-RTT measurements.

For semi-persistent (SP) or aperiodic (AP) UL-SRS, the LMF 508 may optionally request the serving gNB 504 to activate/trigger the UL-SRS in the UE 502, e.g., via an NRPPa UL-SRS Activation Request message 526, which is defined in TS 38.455, section 9.1.1.17, a portion of which is shown below:

TABLE 4
TS 38.455, section 9.1.1.17,
“Positioning Activation Request”

| IE/Group Name | IE Type and Reference |
|---|---|
| NRPPa Transaction ID | 9.2.4 |
| CHOICE SRS Type | |
| aperiodic | |
| SRS Resource Trigger | 9.2.35 |
| Activation Time | 9.2.36 |

Message 526 may include an SRS Resource Trigger information element (IE) such as defined in TS 38.455, section 9.2.35, a portion of which is shown below:

TABLE 5
TS 38.455, section 9.2.35,
“SRS Resource Trigger”

| IE/Group Name | IE Type and Reference |
|---|---|
| Aperiodic SRS Resource Trigger List | |
| Aperiodic SRS Resource Trigger | INTEGER(1..3) |

That is, the LMF 508 picks an SRS resource trigger to be activated via message 526: that trigger is associated with an SRS resource set, and that SRS resource set is associated with a slot offset. In this manner, the LMF 508 tells the gNB 504 when the gNB 504 should send the DCI to the UE 502 and which SRS(s) that DCI should trigger.

The gNB 504 then triggers an aperiodic SRS transmission by the UE 502 (block 528). For AP UL-SRS, if the SRS Resource Trigger IE is included, the NG-RAN node (i.e., the serving gNB 504) shall take the value of the TE into account when the gNB 504 triggers an aperiodic SRS transmission by the UE 502.

The UE 502 performs the DL measurements from all TRPs 506 and the serving gNB 504 provided in the assistance data (block 530). Each configured TRP 506 and the serving gNB 504 performs the UL measurements (block 532). The UE 502 reports the DL measurements to the LMF (message 534). Each TRP reports the UL measurements to the LMF (message(s) 536).

The LMF 508 determines the RTTs from the UE 502 and gNB Rx-Tx Time Difference Measurements for each TRP for which corresponding UL and DL measurements were provided (block 538) and calculates the position of the UE 502 (block 540).

However, in time-domain multiplexing (TDM), if the DCI occurred in a downlink-only (D) slot, then the AP-SRS—an uplink signal—with a slot offset value of 0 could not be transmitted. Likewise, if the next slot was a D slot, then an AP-SRS with a slot offset value of 1 could not be transmitted.

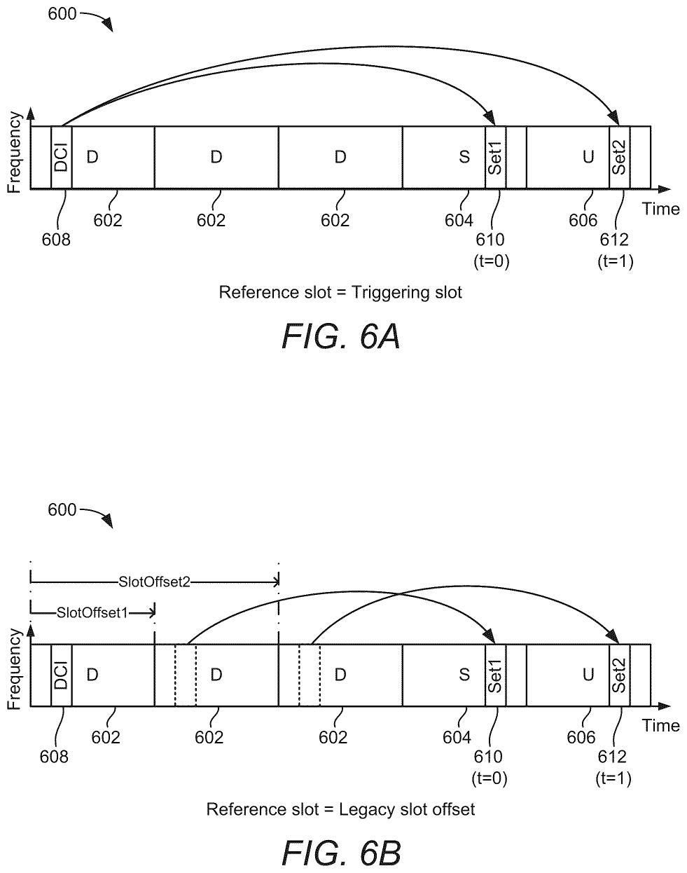

FIGS. 6A and 6B illustrate a solution to this problem according to aspects of the present disclosure. In some aspects, the definition of “slot offset=N” is changed from “the Nth slot after the DCI” to “the Nth available slot after the reference slot,” which may also be referred to as “the Nth available slot with respect to a reference,” or simply “the Nth available slot,” where an “available slot” is a slot having enough UL or flexible symbols for the time-domain location(s) for all the SRS resources in the resource set and it satisfies the minimum timing requirement between triggering PDCCH and all the SRS resources in the resource set, an a “reference slot” can be either the slot with the triggering DCI or the slot indicated by the conventional triggering offset. In some aspects, slot offset of “0” means “the first available slot with respect to the reference”, a slot offset of “1” means “the second available slot with respect to the reference”, and so on.

For example, message 518 in FIG. 5 is based on TS 38.455, section 9.1.1.11, which includes portions defined in TS 38.455, section 9.2.28, which may include portions from TS 38.455, section 9.2.31 (for SRS for MIMO) and TS 38.455, section 9.2.30 (for SRS for Positioning). In some aspects, sections 9.2.30 and 9.2.31 of TS 38.455 may be modified to include a flag to inform the LMF whether the slot offset field should be interpreted as referring to a slot number, as interpreted by legacy networks (and which is referred to herein as a “legacy slot offset value” or a “legacy interpretation of the slot offset field”) or as referring to an available slot number with respect to a reference (which may be referred to herein as a “new slot offset value” or a “new interpretation of the slot offset field”), as shown below, with changes shown in bold, italic font:

TABLE 6
TS 38.455, updated section 9.2.30,
“Positioning SRS Resource”

| IE/Group Name | IE Type and Reference |
|---|---|
| Positioning SRS Resource ID | INTEGER(0..63) |
| CHOICE Resource Type Positioning | INTEGER(0..32) |
| aperiodic | |
| slot offset | |
| Slot Offset Interpretation Flag | |

TABLE 7
TS 38.455, updated section 9.2.31,
“SRS Resource Set”

| IE/Group Name | IE Type and Reference |
|---|---|
| SRS Resource Set ID | INTEGER(0..15) |
| SRS Resource ID List | |
| SRS Resource ID | INTEGER(0.63) |
| CHOICE Resource Set Type | |
| aperiodic | |
| SRS Resource Trigger | INTEGER(1..3) |
| Slot offset | INTEGER(0.32) |
| Slot Offset Interpretation Flag | |

In some aspects, the definition of slot offset does not change, but an additional IE is added to convey a value of “f which indicates which available slot should be used. In some aspects, sections 9.2.30 and 9.2.31 of TS 38.455 may be modified as shown below:

TABLE 8
TS 38.455, updated section 9.2.30,
“Positioning SRS Resource”

| IE/Group Name | IE Type and Reference |
|---|---|
| Positioning SRS Resource ID | INTEGER(0..63) |
| CHOICE Resource Type Positioning | |
| aperiodic | |
| slot offset | INTEGER(0..32) |
| Available Slot offset (T) | INTEGER(0..Tcount) |

TABLE 9
TS 38.455, updated section 9.2.31, “SRS Resource Set”

| IE/Group Name | IE Type and Reference |
|---|---|
| SRS Resource Set ID | INTEGER(0..15) |
| SRS Resource ID List | |
| SRS Resource ID | INTEGER(0..63) |
| CHOICE Resource Set Type | |
| aperiodic | |
| SRS Resource Trigger | INTEGER(1..3) |
| Slot offset | INTEGER(0..32) |
| Available Slot offset (T) | INTEGER(0..Tcount) |

The gNB can determine which slots are available because the gNB knows the frame structure, e.g., which slots are D. S. or U, frame, slot, and symbol structure, etc., which is configured via RRC (and thus semi-static). However, in conventional networks the LMF does not know the frame structure, so this information is provided to the LMF according to some aspects of the present disclosure. In some aspects, this information may be provided as part of the NRPPa Positioning Information Response message 518, e.g., using the updated definition found in TS 38.455, section 9.1.1.11, a portion of which is shown

TABLE 10
TS 38.455, updated section 9.1.1.11,
“Positioning Information Response”

| IE/Group Name | IE Type and Reference |
|---|---|
| NRPPa Transaction ID | 9.2.4 |
| SRS Configuration | 9.2.28 |
| Frame Structure (U/D/S) | |

By providing the LMF with the frame, slot, and symbol structure, the LMF can determine the locations of the “available” slots. In some embodiments, this information may mirror the frame structure configuration information that was configured via RRC.

In some aspects, a slot is considered as “available” according to the rules defined for SRS for multiple input, multiple output (MIMO) configurations, e.g., a slot having enough UL or flexible symbols for the time-domain location(s) for all the SRS resources in the resource set and it satisfies the minimum timing requirement between triggering PDCCH and all the SRS resources in the resource set. In some aspects, when there are multiple SRS resources, the determination of available slots can be determined sequentially. e.g., the SRS resources are considered in order (SRS resource 0 is considered, then SRS resource 1, then SRS resource 2, and so on) to avoid collision. In some aspects, when there are multiple SRS resources, they are all evaluated at the same time, and if two SRS resources overlap in time, one or both of them are dropped or postponed.

Both FIG. 6A and FIG. 6B illustrate a portion of a time and frequency graph 600 showing three D slots 602 followed by a special (S) slot 604 and an uplink (U) slot 606. A DCI 608 includes information that triggers an AP-SRS using a first SRS resource set 610 and an AP-SRS using a second SRS resource set 612. In the example illustrated in FIGS. 6A and 6B, t=0 for SRS resource set 1, and t=1 for SRS resource set 2. In FIG. 6A, the reference is the triggering slot, i.e., the slot in which the DCI 608 was located, and the value of t indicates which available slot after the slot containing the DCI 608 to use. In FIG. 6B, the reference is the slot in which the DCI 608 was located plus the legacy slot offset value, and the value of t indicates which available slot after that reference slot to use. In some aspects, the DCI may indicate different index of the list of T per each resource, or indicate same row index for all resources. In some aspects, if only one value for T is configured, the DCI does not need to indicate a value of T. In some aspects, if no value for T is configured, either the legacy slot offset value may be used or a default value (e.g., T=0) may be used.

In some aspects, signaling enhancements between an LMF and an NG RAN may comprise introducing fields that pick a value of T, e.g., if multiple values of T are configured for an SRS resource or an SRS resource set. For example, in the SRS Resource Trigger message from LMF to NG RAN, such as the NRPPa UL-SRS Activation Request message 526 in FIG. 5, section 9.2.35 may be modified to include an available slot offset indicator, such as shown below:

TABLE 11
TS 38.455, updated section 9.2.35,
“SRS Resource Trigger”

| IE/Group Name | IE Type and Reference |
|---|---|
| Aperiodic SRS Resource Trigger List | |
| Aperiodic SRS Resource Trigger | INTEGER(1..3) |
| Available Slot offset (T) | INTEGER(0..Tcount) |

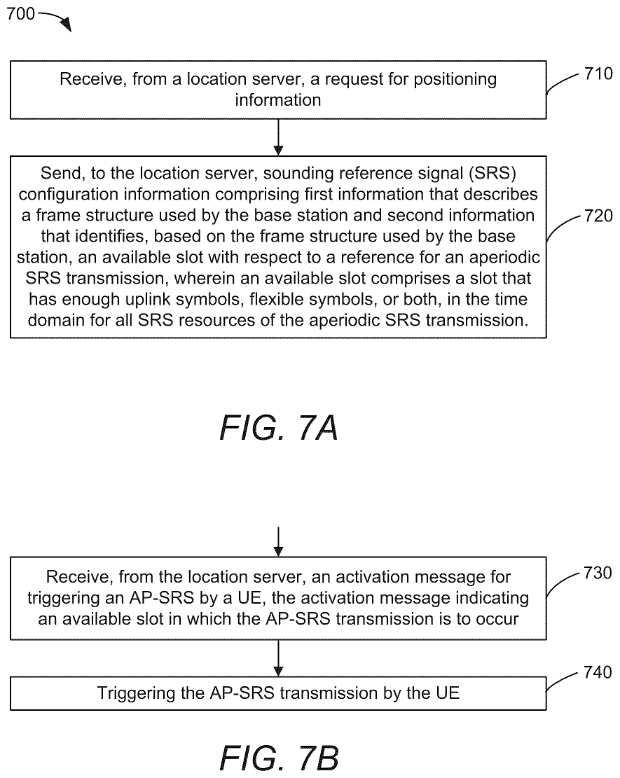

FIG. 7A and FIG. 7B are flowcharts showing portions of an example process 700 associated with signaling for aperiodic SRS for positioning according to aspects of the present disclosure. In some implementations, one or more process blocks of FIGS. 7A and 7B may be performed by a base station (e.g., BS 102). In some aspects, the base station comprises a gNodeB (gNB). In some implementations, one or more process blocks of FIGS. 7A and 7B may be performed by another device or a group of devices separate from or including the base station. Additionally, or alternatively, one or more process blocks of FIGS. 7A and 7B may be performed by one or more components of base station 304, such as processor(s) 384, memory 386, WWAN transceiver(s) 350, short-range wireless transceiver(s) 360, satellite signal receiver 370, and AP-SRS module(s) 388, any or all of which may be means for performing the operations of process 700.

As shown in FIG. 7A, process 700 may include receiving, from a location server, a request for positioning information (block 710). Means for performing the operation of block 710 may include the WWAN transceiver(s) 350 of base station 304. For example, the base station 304 may receive the request for positioning information via the receiver(s) 352. In some aspects, the request for positioning information comprises an NRPPa positioning information request message. In some aspects, the location server comprises a location management function (LMF).

As further shown in FIG. 7A, process 700 may include sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein an available slot comprises a slot that has enough uplink symbols, flexible symbols, or both, in the time domain for all SRS resources of the aperiodic SRS transmission (block 720). Means for performing the operation of block 720 may include the WWAN transceiver(s) 350 of base station 304. For example, the base station 304 may send, the SRS configuration information to the location server via transmitter(s) 354. In some aspects, an available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

In some aspects, the first information that describes a frame structure comprises information such as the number of slots in a frame, the type of each slot (e.g., U, D, or S), the number of symbols in each slot, symbol structure, and so on. In some aspects, the reference for an aperiodic SRS transmission comprises a slot that contains a message that triggers the aperiodic SRS transmission. In some aspects, the reference for an aperiodic SRS transmission comprises a slot indicated by a triggering offset parameter. In some aspects, the aperiodic SRS transmission comprises an SRS for positioning. In some aspects, the aperiodic SRS transmission comprises an SRS for multi-input, multi-output (MIMO). In some aspects, the request for positioning information comprises a NRPPa positioning information request message. In some aspects, the SRS configuration information comprises a NRPPa positioning information response message. In some aspects, the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

As shown in FIG. 7B, process 700 may further include receiving, from the location server, an activation message for triggering an aperiodic SRS transmission by a user equipment (UE), the activation message indicating an available slot with respect to a reference in which the aperiodic SRS transmission is to occur (block 730). Means for performing the operation of block 730 may include the WWAN transceiver(s) 350 of base station 304. For example, the base station 304 may receive the activation message via the receiver(s) 352.

As further shown in FIG. 7B, in some aspects, process 700 may further include triggering the aperiodic SRS transmission by the UE (block 740). Means for performing the operation of block 740 may include the WWAN transceiver(s) 350 of base station 304. For example, the base station 304 may trigger the aperiodic SRS transmission by the UE by sending a downlink control information (DCI) message to the UE via transmitter(s) 354.

Process 700 may include additional implementations, such as any single implementation or any combination of implementations described below and/or in connection with one or more other processes described elsewhere herein. Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

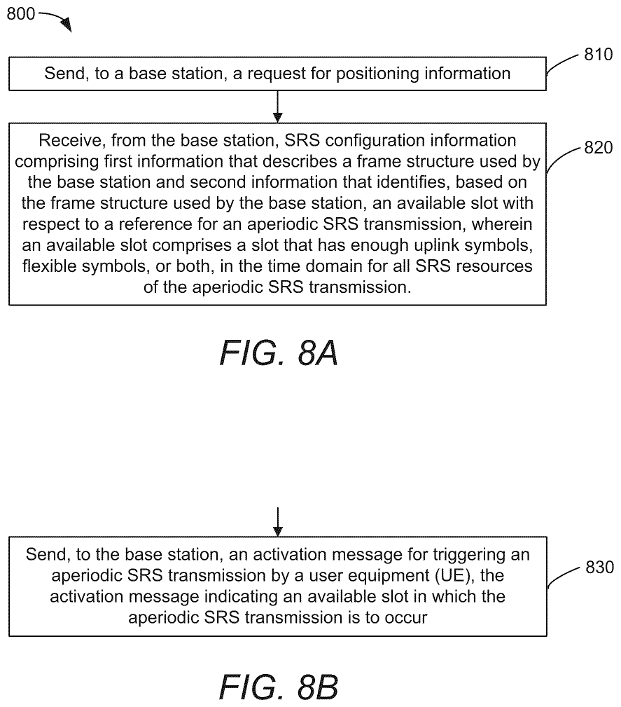

FIG. 8A and FIG. 8B are flowcharts showing portions of an example process 800 associated with signaling for aperiodic SRS for positioning according to aspects of the disclosure. In some implementations, one or more process blocks of FIGS. 8A and 8B may be performed by a location server (e.g., location server 172). In some aspects, the location server comprises a location management function (LMF). In some implementations, one or more process blocks of FIGS. 8A and 8B may be performed by another device or a group of devices separate from or including the location server. Additionally, or alternatively, one or more process blocks of FIGS. 8A and 8B may be performed by one or more components of network node 306, such as processor(s) 394, memory 396, network transceiver(s) 390, and AP-SRS module(s) 398, any or all of which may be means for performing the operations of process 800.

As shown in FIG. 8A, process 800 may include sending, to a base station, a request for positioning information (block 810). Means for performing the operation of block 810 may include the network transceiver(s) 390 of network node 306. For example, the network node 306 may send the request for positioning information via the network transceiver(s) 390. In some aspects, the base station comprises a gNodeB (gNB). In some aspects, the request for positioning information comprises a new radio positioning protocol A (NRPPa) positioning information request message.

As further shown in FIG. 8A, process 800 may include receiving, from the base station, SRS configuration information comprising first information that describes a frame structure used by the base station and second information that identifies, based on the frame structure used by the base station, an available slot with respect to a reference for an aperiodic SRS transmission, wherein an available slot comprises a slot that has enough uplink symbols, flexible symbols, or both, in the time domain for all SRS resources of the aperiodic SRS transmission (block 820). Means for performing the operation of block 820 may include the network transceiver(s) 390 of network node 306. For example, the network node 306 may receive the SRS configuration information via the network transceiver(s) 390. In some aspects, an available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

In some aspects, the first information that describes a frame structure comprises information such as the number of slots in a frame, the type of each slot (e.g., U, D, or S), the number of symbols in each slot, symbol structure, and so on. In some aspects, the reference for an aperiodic SRS transmission comprises a slot that contains a message that triggers the aperiodic SRS transmission. In some aspects, the reference for an aperiodic SRS transmission comprises a slot indicated by a triggering offset parameter. In some aspects, the aperiodic SRS transmission comprises an SRS for positioning. In some aspects, the aperiodic SRS transmission comprises an SRS for multi-input, multi-output (MIMO). In some aspects, the request for positioning information comprises a NRPPa positioning information request message. In some aspects, the SRS configuration information comprises a NRPPa positioning information response message. In some aspects, the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

As shown in FIG. 8B, process 800 may include sending, to the base station, an activation message for triggering an aperiodic SRS transmission by a user equipment (UE), the activation message indicating an available slot with respect to a reference in which the aperiodic SRS transmission is to occur (block 830). Means for performing the operation of block 830 may include the network transceiver(s) 390 of network node 306. For example, the network node 306 may send the activation request to the base station via the network transceiver(s) 390 In some aspects, the activation message comprises an NRPPa UL-SRS Activation Request message.

Process 800 may include additional implementations, such as any single implementation or any combination of implementations described below and/or in connection with one or more other processes described elsewhere herein. Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As will be appreciated, a technical advantage of the methods described herein is that an LMF is provided with enough information that it can determine how to calculate which slots are “available” slots for the purpose of flexibly triggering aperiodic SRS transmissions, so that is can configure the neighboring gNBs for measuring SRS resources of flexibly triggered aperiodic SRS transmissions.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a base station, the method comprising: receiving, from a location server, a request for positioning information; and sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 2. The method of clause 1, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 3. The method ofany of clauses 1 to 2, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 4. The method of any of clauses 1 to 3, wherein the reference for an aperiodic SRS transmission comprises a slot that contains a message that triggers the aperiodic SRS transmission.

Clause 5. The method of any of clauses 1 to 4 wherein the reference for an aperiodic SRS transmission comprises a slot indicated by a triggering offset parameter.

Clause 6. The method of any of clauses 1 to 5, wherein the aperiodic SRS transmission comprises an SRS for positioning.

Clause 7. The method of any of clauses 1 to 6, wherein the aperiodic SRS transmission comprises an SRS for multi-input, multi-output (MIMO).

Clause 8. The method of any of clauses 1 to 7, wherein receiving the request for positioning information comprises receiving a new radio positioning protocol A (NRPPa) positioning information request message and wherein sending the SRS configuration information comprises sending a NRPPa positioning information response message.

Clause 9. The method of any of clauses 1 to 8, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 10. The method of any of clauses 1 to 9, further comprising: receiving, from the location server, an activation message for triggering an aperiodic SRS transmission by a user equipment (UE), the activation message indicating an available slot with respect to a reference in which the aperiodic SRS transmission is to occur.

Clause 11. The method of clause 10, further comprising triggering the aperiodic SRS transmission by the UE.

Clause 12. The method of clause 11, wherein triggering the aperiodic SRS transmission by the UE comprises sending a downlink control information (DCI) message to the UE.

Clause 13. The method of any of clauses 1 to 12, wherein the base station comprises a gNodeB (gNB).

Clause 14. The method of any of clauses 1 to 13, wherein the location server comprises a location management function (LMF).

Clause 15. A method of wireless communication performed by a location server, the method comprising: sending, to a base station, a request for positioning information; and receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 16. The method of clause 15, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 17. The method of any of clauses 15 to 16, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 18. The method of any of clauses 15 to 17, wherein the reference for an aperiodic SRS transmission comprises a slot that contains a message that triggers the aperiodic SRS transmission.

Clause 19. The method of any of clauses 15 to 18, wherein the reference for an aperiodic SRS transmission comprises a slot indicated by a triggering offset parameter.

Clause 20. The method of any of clauses 15 to 19, wherein the aperiodic SRS transmission comprises an SRS for positioning.

Clause 21. The method of any of clauses 15 to 20, wherein the aperiodic SRS transmission comprises an SRS for multi-input, multi-output (MIMO).

Clause 22. The method of any of clauses 15 to 21, wherein sending the request for positioning information comprises sending a new radio positioning protocol A (NRPPa) positioning information request message and wherein receiving the SRS configuration information comprises receiving a NRPPa positioning information response message.

Clause 23. The method of any of clauses 15 to 22, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 24. The method of any of clauses 15 to 23, further comprising: sending, to the base station, an activation message for triggering an aperiodic SRS transmission by a user equipment (UE), the activation message indicating an available slot with respect to a reference in which the aperiodic SRS transmission is to occur.

Clause 25. The method of clause 24, wherein sending the activation message comprises sending a new radio positioning protocol A (NRPPa) uplink SRS (UL-SRS) activation request message.

Clause 26. The method of any of clauses 15 to 25, wherein the base station comprises a gNodeB (gNB).

Clause 27. The method of any of clauses 15 to 26, wherein the location server comprises a location management function (LMF).

Clause 28. A base station (BS), comprising: a memory; at least one transceiver; and at least one processor communicatively coupled to the memory and the at least one transceiver, the at least one processor configured to: receive, via the at least one transceiver, from a location server, a request for positioning information; and send, via the at least one transceiver, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 29. The BS of clause 28, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 30. The BS of any of clauses 28 to 29, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 31. The BS of any of clauses 28 to 30, wherein the reference for an aperiodic SRS transmission comprises a slot that contains a message that triggers the aperiodic SRS transmission.

Clause 32. The BS of any of clauses 28 to 31, wherein the reference for an aperiodic SRS transmission comprises a slot indicated by a triggering offset parameter.

Clause 33. The BS of any of clauses 28 to 32, wherein the aperiodic SRS transmission comprises an SRS for positioning.

Clause 34. The BS of any of clauses 28 to 33, wherein the aperiodic SRS transmission comprises an SRS for multi-input, multi-output (MIMO).

Clause 35. The BS of any of clauses 28 to 34, wherein, to receive the request for positioning information, the at least one processor configured to receive a new radio positioning protocol A (NRPPa) positioning information request message and wherein, to send the SRS configuration information, the at least one processor configured to send a NRPPa positioning information response message.

Clause 36. The BS of any of clauses 28 to 35, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 37. The BS of any of clauses 28 to 36, wherein the at least one processor is further configured to: receive, via the at least one transceiver, from the location server, an activation message for triggering an aperiodic SRS transmission by a user equipment (UE), the activation message indicating an available slot with respect to a reference in which the aperiodic SRS transmission is to occur.

Clause 38. The BS of clause 37, wherein the at least one processor is further configured to trigger the aperiodic SRS transmission by the UE.

Clause 39. The BS of clause 38, wherein, to trigger the aperiodic SRS transmission by the UE, the at least one processor is configured to send a downlink control information (DCI) message to the UE.

Clause 40. The BS of any of clauses 28 to 39, wherein the base station comprises a gNodeB (gNB).

Clause 41. The BS of any of clauses 28 to 40, wherein the location server comprises a location management function (LMF).

Clause 42. A location server (LS), comprising: a memory; at least one transceiver; and at least one processor communicatively coupled to the memory and the at least one transceiver, the at least one processor configured to: send, via the at least one transceiver, to a base station, a request for positioning information; and receive, via the at least one transceiver, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 43. The LS of clause 42, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 44. The LS of any of clauses 42 to 43, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 45. The LS of any of clauses 42 to 44, wherein the reference for an aperiodic SRS transmission comprises a slot that contains a message that triggers the aperiodic SRS transmission.

Clause 46. The LS of any of clauses 42 to 45, wherein the reference for an aperiodic SRS transmission comprises a slot indicated by a triggering offset parameter.

Clause 47. The LS of any of clauses 42 to 46, wherein the aperiodic SRS transmission comprises an SRS for positioning.

Clause 48. The LS of any of clauses 42 to 47, wherein the aperiodic SRS transmission comprises an SRS for multi-input, multi-output (MIMO).

Clause 49. The LS of any of clauses 42 to 48, wherein, to send the request for positioning information, the at least one processor configured to send a new radio positioning protocol A (NRPPa) positioning information request message and wherein, to receive the SRS configuration information, the at least one processor configured to receive a NRPPa positioning information response message.

Clause 50. The LS of any of clauses 42 to 49, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 51. The LS of any of clauses 42 to 50, wherein the at least one processor is further configured to: send, via the at least one transceiver, to the base station, an activation message for triggering an aperiodic SRS transmission by a user equipment (UE), the activation message indicating an available slot with respect to a reference in which the aperiodic SRS transmission is to occur.

Clause 52. The LS of clause 51, wherein, to send the activation message, the at least one processor is configured to send a new radio positioning protocol A (NRPPa) uplink SRS (UL-SRS) activation request message.

Clause 53. The LS of any of clauses 42 to 52, wherein the base station comprises a gNodeB (gNB).

Clause 54. The LS of any of clauses 42 to 53, wherein the location server comprises a location management function (LMF).

Clause 55. A base station (BS), comprising: means for receiving, from a location server, a request for positioning information; and means for sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 56. The BS of clause 55, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 57. The BS of any of clauses 55 to 56, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 58. The BS of any of clauses 55 to 57, wherein the reference for an aperiodic SRS transmission comprises a slot that contains a message that triggers the aperiodic SRS transmission.

Clause 59. The BS of any of clauses 55 to 58, wherein the reference for an aperiodic SRS transmission comprises a slot indicated by a triggering offset parameter.

Clause 60. The BS of any of clauses 55 to 59, wherein the aperiodic SRS transmission comprises an SRS for positioning.

Clause 61. The BS of any of clauses 55 to 60, wherein the aperiodic SRS transmission comprises an SRS for multi-input, multi-output (MIMO).

Clause 62. The BS of any of clauses 55 to 61, wherein the means for receiving the request for positioning information comprises means for receiving a new radio positioning protocol A (NRPPa) positioning information request message and wherein the means for sending the SRS configuration information comprises means for sending a NRPPa positioning information response message.

Clause 63. The BS of any of clauses 55 to 62, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 64. The BS of any of clauses 55 to 63, further comprising: means for receiving, from the location server, an activation message for triggering an aperiodic SRS transmission by a user equipment (UE), the activation message indicating an available slot with respect to a reference in which the aperiodic SRS transmission is to occur.

Clause 65. The BS of clause 64, further comprising means for triggering the aperiodic SRS transmission by the UE.

Clause 66. The BS of clause 65, wherein the means for triggering the aperiodic SRS transmission by the UE comprises means for sending a downlink control information (DCI) message to the UE.

Clause 67. The BS of any of clauses 55 to 66, wherein the base station comprises a gNodeB (gNB).

Clause 68. The BS of any of clauses 55 to 67, wherein the location server comprises a location management function (LMF).

Clause 69. A location server (LS), comprising: means for sending, to a base station, a request for positioning information; and means for receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 70. The LS of clause 69, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 71. The LS of any of clauses 69 to 70, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 72. The LS of any of clauses 69 to 71, wherein the reference for an aperiodic SRS transmission comprises a slot that contains a message that triggers the aperiodic SRS transmission.

Clause 73. The LS of any of clauses 69 to 72, wherein the reference for an aperiodic SRS transmission comprises a slot indicated by a triggering offset parameter.

Clause 74. The LS of any of clauses 69 to 73, wherein the aperiodic SRS transmission comprises an SRS for positioning.

Clause 75. The LS of any of clauses 69 to 74, wherein the aperiodic SRS transmission comprises an SRS for multi-input, multi-output (MIMO).

Clause 76. The LS of any of clauses 69 to 75, wherein the means for sending the request for positioning information comprises means for sending a new radio positioning protocol A (NRPPa) positioning information request message and wherein the means for receiving the SRS configuration information comprises means for receiving a NRPPa positioning information response message.

Clause 77. The LS of any of clauses 69 to 76, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 78. The LS of any of clauses 69 to 77, further comprising: means for sending, to the base station, an activation message for triggering an aperiodic SRS transmission by a user equipment (UE), the activation message indicating an available slot with respect to a reference in which the aperiodic SRS transmission is to occur.

Clause 79. The LS of clause 78, wherein the means for sending the activation message comprises means for sending a new radio positioning protocol A (NRPPa) uplink SRS (UL-SRS) activation request message.

Clause 80. The LS of any of clauses 69 to 79, wherein the base station comprises a gNodeB (gNB).

Clause 81. The LS of any of clauses 69 to 80, wherein the location server comprises a location management function (LMF).

Clause 82. A non-transitory computer-readable medium storing computer-executable instructions that, when executed by a base station (BS), cause the BS to: receive, from a location server, a request for positioning information; and send, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 83. The non-transitory computer-readable medium of clause 82, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 84. The non-transitory computer-readable medium of any of clauses 82 to 83, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 85. The non-transitory computer-readable medium of any of clauses 82 to 84, wherein the reference for an aperiodic SRS transmission comprises a slot that contains a message that triggers the aperiodic SRS transmission.

Clause 86. The non-transitory computer-readable medium of any of clauses 82 to 85, wherein the reference for an aperiodic SRS transmission comprises a slot indicated by a triggering offset parameter.

Clause 87. The non-transitory computer-readable medium of any of clauses 82 to 86, wherein the aperiodic SRS transmission comprises an SRS for positioning.

Clause 88. The non-transitory computer-readable medium of any of clauses 82 to 87, wherein the aperiodic SRS transmission comprises an SRS for multi-input, multi-output (MIMO).

Clause 89. The non-transitory computer-readable medium of any of clauses 82 to 88, wherein the computer-executable instructions that, when executed by the BS, cause the BS to receive the request for positioning information, comprise computer-executable instructions that, when executed by the BS, cause the BS to receive a new radio positioning protocol A (NRPPa) positioning information request message and wherein the computer-executable instructions that, when executed by the BS, cause the BS to send the SRS configuration information, comprise computer-executable instructions that, when executed by the BS, cause the BS to send a NRPPa positioning information response message.

Clause 90. The non-transitory computer-readable medium of any of clauses 82 to 89, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 91. The non-transitory computer-readable medium of any of clauses 82 to 90, further comprising computer-executable instructions that, when executed by BS, further cause the BS to: receive, from the location server, an activation message for triggering an aperiodic SRS transmission by a user equipment (UE), the activation message indicating an available slot with respect to a reference in which the aperiodic SRS transmission is to occur.

Clause 92. The non-transitory computer-readable medium of clause 91, further comprising computer-executable instructions that, when executed by BS, further cause the BS to trigger the aperiodic SRS transmission by the UE.

Clause 93. The non-transitory computer-readable medium of clause 92, wherein the computer-executable instructions that cause the BS to trigger the aperiodic SRS transmission by the UE comprise computer-executable instructions that cause the BS to send a downlink control information (DCI) message to the UE.

Clause 94. The non-transitory computer-readable medium of any of clauses 82 to 93, wherein the base station comprises a gNodeB (gNB).

Clause 95. The non-transitory computer-readable medium of any of clauses 82 to 94, wherein the location server comprises a location management function (LMF).

Clause 96. A non-transitory computer-readable medium storing computer-executable instructions that, when executed by a location server (LS), cause the LS to: send, to a base station, a request for positioning information; and receive, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

Clause 97. The non-transitory computer-readable medium of clause 96, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

Clause 98. The non-transitory computer-readable medium of any of clauses 96 to 97, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

Clause 99. The non-transitory computer-readable medium of any of clauses 96 to 98, wherein the reference for an aperiodic SRS transmission comprises a slot that contains a message that triggers the aperiodic SRS transmission.

Clause 100. The non-transitory computer-readable medium of any of clauses 96 to 99, wherein the reference for an aperiodic SRS transmission comprises a slot indicated by a triggering offset parameter.

Clause 101. The non-transitory computer-readable medium of any of clauses 96 to 100, wherein the aperiodic SRS transmission comprises an SRS for positioning.

Clause 102. The non-transitory computer-readable medium of any of clauses 96 to 101, wherein the aperiodic SRS transmission comprises an SRS for multi-input, multi-output (MIMO).

Clause 103. The non-transitory computer-readable medium of any of clauses 96 to 102, wherein sending the request for positioning information comprises sending a new radio positioning protocol A (NRPPa) positioning information request message and wherein receiving the SRS configuration information comprises receiving a NRPPa positioning information response message.

Clause 104. The non-transitory computer-readable medium of any of clauses 96 to 103, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

Clause 105. The non-transitory computer-readable medium of any of clauses 96 to 104, further comprising computer-executable instructions that, when executed by LS, further cause the LS to: send, to the base station, an activation message for triggering an aperiodic SRS transmission by a user equipment (UE), the activation message indicating an available slot with respect to a reference in which the aperiodic SRS transmission is to occur.

Clause 106. The non-transitory computer-readable medium of clause 105, wherein the computer-executable instructions that cause the LS to send the activation message comprise computer-executable instructions that cause the LS to send a new radio positioning protocol A (NRPPa) uplink SRS (UL-SRS) activation request message.

Clause 107. The non-transitory computer-readable medium of any of clauses 96 to 106, wherein the base station comprises a gNodeB (gNB).

Clause 108. The non-transitory computer-readable medium of any of clauses 96 to 107, wherein the location server comprises a location management function (LMF).

Clause 109. An apparatus comprising a memory, a transceiver, and a processor communicatively coupled to the memory and the transceiver, the memory, the transceiver, and the processor configured to perform a method according to any of clauses 1 to 27.

Clause 110. An apparatus comprising means for performing a method according to any of clauses 1 to 27.

Clause 111. A non-transitory computer-readable medium storing computer-executable instructions, the computer-executable comprising at least one instruction for causing a computer or processor to perform a method according to any of clauses 1 to 27.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a base station, the method comprising:
receiving, from a location server, a request for positioning information; and
sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

2. The method of claim 1, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

3. The method of claim 1, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

4. The method of claim 1, wherein the reference for an aperiodic SRS transmission comprises a slot that contains a message that triggers the aperiodic SRS transmission.

5. The method of claim 1 wherein the reference for an aperiodic SRS transmission comprises a slot indicated by a triggering offset parameter.

6. The method of claim 1, wherein the aperiodic SRS transmission comprises an SRS for positioning.

7. The method of claim 1, wherein the aperiodic SRS transmission comprises an SRS for multi-input, multi-output (MIMO).

8. The method of claim 1, wherein receiving the request for positioning information comprises receiving a new radio positioning protocol A (NRPPa) positioning information request message and wherein sending the SRS configuration information comprises sending a NRPPa positioning information response message.

9. The method of claim 1, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

10. The method of claim 1, further comprising:
receiving, from the location server, an activation message for triggering an aperiodic SRS transmission by a user equipment (UE), the activation message indicating an available slot with respect to a reference in which the aperiodic SRS transmission is to occur.

11. The method of claim 10, further comprising:
triggering the aperiodic SRS transmission by the UE.

12. The method of claim 11, wherein triggering the aperiodic SRS transmission by the UE comprises sending a downlink control information (DCI) message to the UE.

13. The method of claim 1, wherein the base station comprises a gNodeB (gNB).

14. The method of claim 1, wherein the location server comprises a location management function (LMF).

15. A method of wireless communication performed by a location server, the method comprising:
sending, to a base station, a request for positioning information; and
receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

16. The method of claim 15, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

17. The method of claim 15, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

18. The method of claim 15, wherein the reference for an aperiodic SRS transmission comprises a slot that contains a message that triggers the aperiodic SRS transmission.

19. The method of claim 15, wherein the reference for an aperiodic SRS transmission comprises a slot indicated by a triggering offset parameter.

20. The method of claim 15, wherein the aperiodic SRS transmission comprises an SRS for positioning.

21. The method of claim 15, wherein the aperiodic SRS transmission comprises an SRS for multi-input, multi-output (MIMO).

22. The method of claim 15, wherein sending the request for positioning information comprises sending a new radio positioning protocol A (NRPPa) positioning information request message and wherein receiving the SRS configuration information comprises receiving a NRPPa positioning information response message.

23. The method of claim 15, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

24. The method of claim 15, further comprising:
sending, to the base station, an activation message for triggering an aperiodic SRS transmission by a user equipment (UE), the activation message indicating an available slot with respect to a reference in which the aperiodic SRS transmission is to occur.

25. The method of claim 24, wherein sending the activation message comprises sending a new radio positioning protocol A (NRPPa) uplink SRS (UL-SRS) activation request message.

26. The method of claim 15, wherein the base station comprises a gNodeB (gNB).

27. The method of claim 15, wherein the location server comprises a location management function (LMF).

28. A base station (BS), comprising:
a memory;
at least one transceiver; and
at least one processor communicatively coupled to the memory and the at least one transceiver, the at least one processor configured to:
receive, via the at least one transceiver, from a location server, a request for positioning information; and
send, via the at least one transceiver, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

29. The BS of claim 28, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

30. The BS of claim 28, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

31. The BS of claim 28, wherein the reference for an aperiodic SRS transmission comprises a slot that contains a message that triggers the aperiodic SRS transmission.

32. The BS of claim 28, wherein the reference for an aperiodic SRS transmission comprises a slot indicated by a triggering offset parameter.

33. The BS of claim 28, wherein the aperiodic SRS transmission comprises an SRS for positioning.

34. The BS of claim 28, wherein the aperiodic SRS transmission comprises an SRS for multi-input, multi-output (MIMO).

35. The BS of claim 28, wherein, to receive the request for positioning information, the at least one processor configured to receive a new radio positioning protocol A (NRPPa) positioning information request message and wherein, to send the SRS configuration information, the at least one processor configured to send a NRPPa positioning information response message.

36. The BS of claim 28, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

37. The BS of claim 28, wherein the at least one processor is further configured to:
receive, via the at least one transceiver, from the location server, an activation message for triggering an aperiodic SRS transmission by a user equipment (UE), the activation message indicating an available slot with respect to a reference in which the aperiodic SRS transmission is to occur.

38. The BS of claim 37, wherein the at least one processor is further configured to trigger the aperiodic SRS transmission by the UE.

39. The BS of claim 38, wherein, to trigger the aperiodic SRS transmission by the UE, the at least one processor is configured to send a downlink control information (DCI) message to the UE.

40. The BS of claim 28, wherein the base station comprises a gNodeB (gNB).

41. The BS of claim 28, wherein the location server comprises a location management function (LMF).

42. A location server (LS), comprising:
a memory;
at least one transceiver; and
at least one processor communicatively coupled to the memory and the at least one transceiver, the at least one processor configured to:
send, via the at least one transceiver, to a base station, a request for positioning information; and
receive, via the at least one transceiver, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

43. The LS of claim 42, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

44. The LS of claim 42, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

45. The LS of claim 42, wherein the reference for an aperiodic SRS transmission comprises a slot that contains a message that triggers the aperiodic SRS transmission.

46. The LS of claim 42, wherein the reference for an aperiodic SRS transmission comprises a slot indicated by a triggering offset parameter.

47. The LS of claim 42, wherein the aperiodic SRS transmission comprises an SRS for positioning.

48. The LS of claim 42, wherein the aperiodic SRS transmission comprises an SRS for multi-input, multi-output (MIMO).

49. The LS of claim 42, wherein, to send the request for positioning information, the at least one processor configured to send a new radio positioning protocol A (NRPPa) positioning information request message and wherein, to receive the SRS configuration information, the at least one processor configured to receive a NRPPa positioning information response message.

50. The LS of claim 42, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

51. The LS of claim 42, wherein the at least one processor is further configured to:
send, via the at least one transceiver, to the base station, an activation message for triggering an aperiodic SRS transmission by a user equipment (UE), the activation message indicating an available slot with respect to a reference in which the aperiodic SRS transmission is to occur.

52. The LS of claim 51, wherein, to send the activation message, the at least one processor is configured to send a new radio positioning protocol A (NRPPa) uplink SRS (UL-SRS) activation request message.

53. The LS of claim 42, wherein the base station comprises a gNodeB (gNB).

54. The LS of claim 42, wherein the location server comprises a location management function (LMF).

55. A base station (BS), comprising:
means for receiving, from a location server, a request for positioning information; and
means for sending, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

56. The BS of claim 55, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

57. The BS of claim 55, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

58. The BS of claim 55, wherein the reference for an aperiodic SRS transmission comprises a slot that contains a message that triggers the aperiodic SRS transmission.

59. The BS of claim 55, wherein the reference for an aperiodic SRS transmission comprises a slot indicated by a triggering offset parameter.

60. The BS of claim 55, wherein the aperiodic SRS transmission comprises an SRS for positioning.

61. The BS of claim 55, wherein the aperiodic SRS transmission comprises an SRS for multi-input, multi-output (MIMO).

62. The BS of claim 55, wherein the means for receiving the request for positioning information comprises means for receiving a new radio positioning protocol A (NRPPa) positioning information request message and wherein the means for sending the SRS configuration information comprises means for sending a NRPPa positioning information response message.

63. The BS of claim 55, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

64. The BS of claim 55, further comprising:
means for receiving, from the location server, an activation message for triggering an aperiodic SRS transmission by a user equipment (UE), the activation message indicating an available slot with respect to a reference in which the aperiodic SRS transmission is to occur.

65. The BS of claim 64, further comprising means for triggering the aperiodic SRS transmission by the UE.

66. The BS of claim 65, wherein the means for triggering the aperiodic SRS transmission by the UE comprises means for sending a downlink control information (DCI) message to the UE.

67. The BS of claim 55, wherein the base station comprises a gNodeB (gNB).

68. The BS of claim 55, wherein the location server comprises a location management function (LMF).

69. A location server (LS), comprising:
means for sending, to a base station, a request for positioning information; and
means for receiving, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

70. The LS of claim 69, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

71. The LS of claim 69, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

72. The LS of claim 69, wherein the reference for an aperiodic SRS transmission comprises a slot that contains a message that triggers the aperiodic SRS transmission.

73. The LS of claim 69, wherein the reference for an aperiodic SRS transmission comprises a slot indicated by a triggering offset parameter.

74. The LS of claim 69, wherein the aperiodic SRS transmission comprises an SRS for positioning.

75. The LS of claim 69, wherein the aperiodic SRS transmission comprises an SRS for multi-input, multi-output (MIMO).

76. The LS of claim 69, wherein the means for sending the request for positioning information comprises means for sending a new radio positioning protocol A (NRPPa) positioning information request message and wherein the means for receiving the SRS configuration information comprises means for receiving a NRPPa positioning information response message.

77. The LS of claim 69, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

78. The LS of claim 69, further comprising:
means for sending, to the base station, an activation message for triggering an aperiodic SRS transmission by a user equipment (UE), the activation message indicating an available slot with respect to a reference in which the aperiodic SRS transmission is to occur.

79. The LS of claim 78, wherein the means for sending the activation message comprises means for sending a new radio positioning protocol A (NRPPa) uplink SRS (UL-SRS) activation request message.

80. The LS of claim 69, wherein the base station comprises a gNodeB (gNB).

81. The LS of claim 69, wherein the location server comprises a location management function (LMF).

82. A non-transitory computer-readable medium storing computer-executable instructions that, when executed by a base station (BS), cause the BS to:
receive, from a location server, a request for positioning information; and
send, to the location server, sounding reference signal (SRS) configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

83. The non-transitory computer-readable medium of claim 82, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

84. The non-transitory computer-readable medium of claim 82, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

85. The non-transitory computer-readable medium of claim 82, wherein the reference for an aperiodic SRS transmission comprises a slot that contains a message that triggers the aperiodic SRS transmission.

86. The non-transitory computer-readable medium of claim 82, wherein the reference for an aperiodic SRS transmission comprises a slot indicated by a triggering offset parameter.

87. The non-transitory computer-readable medium of claim 82, wherein the aperiodic SRS transmission comprises an SRS for positioning.

88. The non-transitory computer-readable medium of claim 82, wherein the aperiodic SRS transmission comprises an SRS for multi-input, multi-output (MIMO).

89. The non-transitory computer-readable medium of claim 82, wherein the computer-executable instructions that, when executed by the BS, cause the BS to receive the request for positioning information, comprise computer-executable instructions that, when executed by the BS, cause the BS to receive a new radio positioning protocol A (NRPPa) positioning information request message and wherein the computer-executable instructions that, when executed by the BS, cause the BS to send the SRS configuration information, comprise computer-executable instructions that, when executed by the BS, cause the BS to send a NRPPa positioning information response message.

90. The non-transitory computer-readable medium of claim 82, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

91. The non-transitory computer-readable medium of claim 82, further comprising computer-executable instructions that, when executed by BS, further cause the BS to:
receive, from the location server, an activation message for triggering an aperiodic SRS transmission by a user equipment (UE), the activation message indicating an available slot with respect to a reference in which the aperiodic SRS transmission is to occur.

92. The non-transitory computer-readable medium of claim 91, further comprising computer-executable instructions that, when executed by BS, further cause the BS to trigger the aperiodic SRS transmission by the UE.

93. The non-transitory computer-readable medium of claim 92, wherein the computer-executable instructions that cause the BS to trigger the aperiodic SRS transmission by the UE comprise computer-executable instructions that cause the BS to send a downlink control information (DCI) message to the UE.

94. The non-transitory computer-readable medium of claim 82, wherein the base station comprises a gNodeB (gNB).

95. The non-transitory computer-readable medium of claim 82, wherein the location server comprises a location management function (LMF).

96. A non-transitory computer-readable medium storing computer-executable instructions that, when executed by a location server (LS), cause the LS to:
send, to a base station, a request for positioning information; and
receive, from the base station, SRS configuration information comprising first information that describes a frame structure used by the base station and second information that identifies, based on the frame structure used by the base station, an available slot with respect to a reference for an aperiodic SRS transmission, wherein the available slot comprises a slot that has enough uplink symbols, flexible symbols, or both, in a time domain for all SRS resources of the aperiodic SRS transmission.

97. The non-transitory computer-readable medium of claim 96, wherein the available slot comprises a slot that has enough uplink symbols, flexible symbols, or both in the time domain for all of the SRS resources of the aperiodic SRS transmission and that also satisfies a minimum timing requirement between a message that triggers the aperiodic SRS transmission and all of the SRS resources used by the aperiodic SRS transmission.

98. The non-transitory computer-readable medium of claim 96, wherein the first information that describes the frame structure used by the base station comprises information that indicates a number of slots in the frame, a slot type of each slot, the slot type comprising an uplink slot, a downlink slot, or a special slot, a number of symbols in each slot, a symbol structure of each slot, or combinations thereof.

99. The non-transitory computer-readable medium of claim 96, wherein the reference for an aperiodic SRS transmission comprises a slot that contains a message that triggers the aperiodic SRS transmission.

100. The non-transitory computer-readable medium of claim 96, wherein the reference for an aperiodic SRS transmission comprises a slot indicated by a triggering offset parameter.

101. The non-transitory computer-readable medium of claim 96, wherein the aperiodic SRS transmission comprises an SRS for positioning.

102. The non-transitory computer-readable medium of claim 96, wherein the aperiodic SRS transmission comprises an SRS for multi-input, multi-output (MIMO).

103. The non-transitory computer-readable medium of claim 96, wherein sending the request for positioning information comprises sending a new radio positioning protocol A (NRPPa) positioning information request message and wherein receiving the SRS configuration information comprises receiving a NRPPa positioning information response message.

104. The non-transitory computer-readable medium of claim 96, wherein the second information that identifies an available slot with respect to a reference for an aperiodic SRS transmission comprises a positioning SRS resource information element comprising a slot offset interpretation flag or an available slot offset value, an SRS resource set information element comprising a slot offset interpretation flag or an available slot offset value, or a combination thereof.

105. The non-transitory computer-readable medium of claim 96, further comprising computer-executable instructions that, when executed by LS, further cause the LS to:
send, to the base station, an activation message for triggering an aperiodic SRS transmission by a user equipment (UE), the activation message indicating an available slot with respect to a reference in which the aperiodic SRS transmission is to occur.

106. The non-transitory computer-readable medium of claim 105, wherein the computer-executable instructions that cause the LS to send the activation message comprise computer-executable instructions that cause the LS to send a new radio positioning protocol A (NRPPa) uplink SRS (UL-SRS) activation request message.

107. The non-transitory computer-readable medium of claim 96, wherein the base station comprises a gNodeB (gNB).

108. The non-transitory computer-readable medium of claim 96, wherein the location server comprises a location management function (LMF).
